(19) United States
(12) Patent Application Publication
(10) Pub. No.: US 2013/0302771 A1
(43) Pub. Date: Nov. 14, 2013

(54) THREE-DIMENSIONAL MUSCLE AND FASCIAL PIECES

(71) Applicant: Suzanne Renee Alderete, Austin, TX (US)

(72) Inventor: Suzanne Renee Alderete, Austin, TX (US)

(21) Appl. No.: 13/864,876

(22) Filed: Apr. 17, 2013

Related U.S. Application Data
(60) Provisional application No. 61/625,307, filed on Apr. 17, 2012.

(51) Int. Cl. G09B 23/28

(52) U.S. Cl. CPC G09B 23/28
USPC 434/267

(57) ABSTRACT

A plurality of muscle pieces includes individual muscle pieces that correspond to individual muscles in the human body. Each muscle piece may be attached to a skeleton model of the human body at a location of the muscle to which the muscle piece corresponds. Each muscle piece may be separately attached to the skeleton model. The muscle pieces may be attached to the skeleton model in one or more layers on the skeleton model. The muscle pieces may be both attached to and removed from the skeleton model during use.

### PRIORITY CLAIM

This patent claims priority to U.S. Provisional Patent Application No. 61/625,307 to Alderete, entitled “MUSCLE PUZZLES”, filed Apr. 17, 2012, which is incorporated by reference in its entirety.

### BACKGROUND

1. Field of the Invention

The present invention relates to representations of human muscles. More particularly, the invention relates to pieces corresponding to different muscles of the human body that are useable on a three-dimensional model.

2. Description of Related Art

Textbooks describing the anatomy of the human body have been around for years. Most kinesiology and anatomy classes rely on textbooks and their pictures to teach students what muscles are and how they are related to each other. While it is possible for students to learn about anatomy and kinesiology through pictures (or computer simulations in some cases), there can be any number of students that have a difficult time grasping certain concepts without seeing the actual concept (e.g., origin and insertion of muscles) in a three-dimensional and/or practical representation. Though there have been developments in how systems in the human body are described and in illustrating the various systems in the human body (e.g., the muscular system), there is still a need for simple but representative systems to describe systems such as muscles and their relation to the human body (e.g., skeleton) in three-dimensional, practical, and/or interactive displays.

### SUMMARY

In certain embodiments, a system includes a plurality of muscle pieces. Each muscle piece may correspond to an individual muscle in the human body. Each muscle piece may be attached to a skeleton model of the human body at a location of the muscle to which the muscle piece corresponds. Each muscle piece may be separately attached to the skeleton model. The muscle pieces may be attached to the skeleton model in one or more layers on the skeleton model. The muscle pieces may be both attached to and removed from the skeleton model during use. In some embodiments, each muscle piece is repeatedly attached to and repeatedly removed from the skeleton model. In some embodiments, at least two muscle pieces at least partially overlap when attached to the skeleton model. In some embodiments, the skeleton model is a three-dimensional skeleton model.

In some embodiments, the muscle pieces are made of varying colors that are varied to correspond to different layers of muscle in the human body. Each muscle piece may have a color that corresponds to the layer of its corresponding muscle in the human body. Each muscle piece may be attached to the skeleton model at a point of insertion and/or origin in the human body of the corresponding muscle.

In certain embodiments, a method for forming a muscle pattern corresponding to a selected muscle in a human body includes draping a piece of material (e.g., a piece of fabric material) on a three-dimensional model of a skeleton at a location of the selected muscle on the human body. A pattern of the selected muscle may be drawn on the material piece. The material piece may be removed from the skeleton model and the muscle pattern may be straightened out on the material piece. The muscle pattern may be cut out from the material piece and then redraped on the skeleton model. A shape and size of the muscle pattern may be assessed to see if the muscle pattern properly represents the selected muscle when the muscle pattern is draped on the skeleton. The shape and size of the muscle pattern may be fine-tuned as needed until the muscle pattern properly represents the selected muscle when the muscle pattern is draped on the skeleton.

In some embodiments, fine-tuning the shape and size of the muscle pattern includes removing the muscle pattern from the skeleton model, recutting the muscle pattern, redraping the muscle pattern on the skeleton model, and reassessing the shape and size of the muscle pattern. In some embodiments, the muscle pattern is used to define a muscle piece on a sheet of material corresponding to the selected muscle. The muscle pattern may be converted into a digital format and the digital format of the muscle pattern is used to define the muscle piece on the sheet of material corresponding to the selected muscle. The method may be repeated with additional pieces of material to form additional muscle patterns for additional selected muscles in the human body.

In certain embodiments, a system includes a plurality of fascial line pieces. Each fascial line piece may correspond to an individual fascial line of muscles in a human body. Each fascial line piece may be separately placed on a skeleton model of the human body at a location of the fascial line of muscles to which the fascial line piece corresponds. A fascial line piece may include two or more muscle pieces coupled together in one or more fascial linking materials. Each muscle piece may correspond to an individual muscle in the fascial line of muscles to which the fascial line piece corresponds. The fascial line pieces may be both placed on and removed from the skeleton model. In some embodiments, each fascial line piece is repeatedly placed on and repeatedly removed from the skeleton model. In some embodiments, at least two fascial line pieces at least partially overlap when placed on the skeleton model.

In some embodiments, the fascial linking material is a stretchy netting material and the muscle pieces are a stretchy fleece material. In some embodiments, the muscle pieces are made of varying colors that are varied to correspond to different layers of muscle in the human body. Each muscle piece has a color corresponding to the layer of its corresponding muscle in the human body and each fascial line piece includes muscle pieces with substantially the same color.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a flowchart for an embodiment of a process used to produce muscle patterns.

FIG. 2 depicts an example of an embodiment of muscle patterns draped on a skeleton.

FIG. 3 depicts one example of an embodiment of a set of muscle pieces defined on a sheet.

FIG. 4 depicts another example of an embodiment of a set of muscle pieces defined on a sheet.

FIG. 5 depicts an additional example of an embodiment of a set of muscle pieces defined on a sheet.

FIG. 6 depicts yet another example of an embodiment of a set of muscle pieces defined on a sheet.

FIG. 7 depicts an example of back muscle pieces placed on a skeleton model.

FIG. 8 depicts an example of arm muscle pieces placed on a skeleton model.

FIG. 9 depicts an example of inner thigh muscle pieces placed on a skeleton model

FIG. 10 depicts an example of quadricep muscle pieces placed on a skeleton model.

FIG. 11 depicts examples of different sets of muscle pieces aligned into different fascial line pieces.

FIG. 12 depicts an embodiment of muscle pieces coupled together using fascial linking material to form a fascial line piece.

FIG. 13 depicts an example of two fascial line pieces placed on a skeleton model.

FIG. 14 depicts an example of an embodiment of pelvic floor muscle patterns corresponding to the seven major pelvic floor muscles.

FIG. 15 depicts an example of outlines of muscle patterns traced on graph paper.

FIG. 16 depicts an example of muscle pattern layed on top of the outlines of muscle patterns on graph paper.

FIG. 17 depicts an example of partial outlines of muscle traced on graph paper.

FIG. 18 depicts an example of cutouts of muscle patterns placed on graph paper.

FIG. 19 depicts an example of cutouts of seven muscle patterns overlayed to show the proper fit together of the muscle patterns.

FIG. 20 depicts an example of an embodiment of muscle pieces placed on fascial linking material.

FIG. 21 depicts an example of an embodiment of a muscle piece placed on fascial linking material.

FIG. 22 depicts another example of an embodiment of muscle pieces placed on fascial linking material.

FIG. 23 depicts an example of an embodiment of one level of a muscle piece and fascial linking material layered on top of another layer of muscle pieces and fascial linking material.

FIG. 24 depicts an example of an embodiment of muscle pieces and fascial linking material layered over the pieces shown in FIG. 23 to produce a pelvic floor fascial line piece.

FIG. 25 depicts an embodiment of a fascial line piece placed in the pelvic floor area of a skeleton model.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF EMBODIMENTS

In the context of this patent, the term “coupled” means either a direct connection or an indirect connection (e.g., one or more intervening connections) between one or more objects or components. The phrase “directly connected” means a direct connection between objects or components such that the objects or components are connected directly to each other so that the objects or components operate in a “point of use” manner.

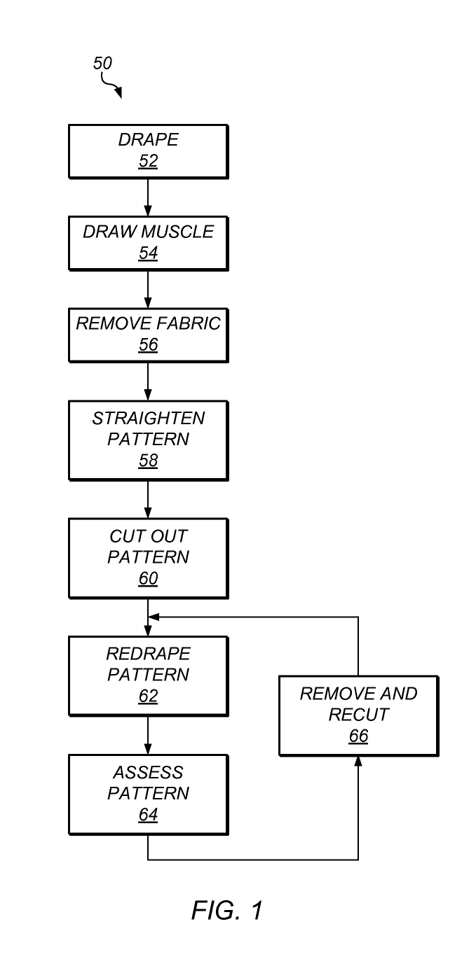

FIG. 1 depicts a flowchart for an embodiment of process 50 used to produce muscle patterns. In “DRAPE 52”, a fabric or fabric-like material may be draped or hung on a three dimensional skeleton (e.g., a human skeleton model). The fabric may be draped to follow the curvature of skeleton to represent the muscle intended to be defined with the fabric. While the fabric is draped on the skeleton, an initial pattern of a muscle may be drawn on the skeleton in “DRAW MUSCLE 54”. Knowledge of the shape, size, layer in the body, origin, insertion, and action of the muscle is used to define and draw the muscle on the fabric in a desired pattern.

After drawing the initial pattern in 54, the fabric may be removed from the skeleton in “REMOVE FABRIC 56”. The initial pattern on the fabric may then be straightened out in “STRAIGHTEN PATTERN 58”. For example, the pattern is transposed from the three-dimensional curved pattern on the skeleton to a flat, two-dimensional pattern and a fine-tuned shape of each muscle pattern may be drawn. Fine-tuning the shape of each muscle pattern may include hand drawing the perimeter of the shape to as close to a final perimeter shape as possible. The initial pattern may be cut out of the fabric in “CUT OUT PATTERN 60” after straightening out the pattern. After cutting out the initial pattern, the fabric may be redraped on the skeleton in “REDRAPE PATTERN 62”.

Once the fabric is redraped on the skeleton, the pattern may be assessed tuned in “ASSESS PATTERN 64”. For example, the pattern may be assessed for to see if the pattern has a selected shape and size that properly represents its corresponding muscle when redraped on the skeleton. In some embodiments, the pattern is marked for further cutting and/or reshaping after assessing the pattern (e.g., the pattern is fine-tuned). If further cutting is needed after 64, the pattern may be removed from the skeleton and recut in “REMOVE AND RECUT 66” and then redraped back at 62. The redraping and recutting process may be repeated until the fabric is fine-tuned into the pattern with the selected shape and size to properly represent its corresponding muscle when draped on the skeleton.

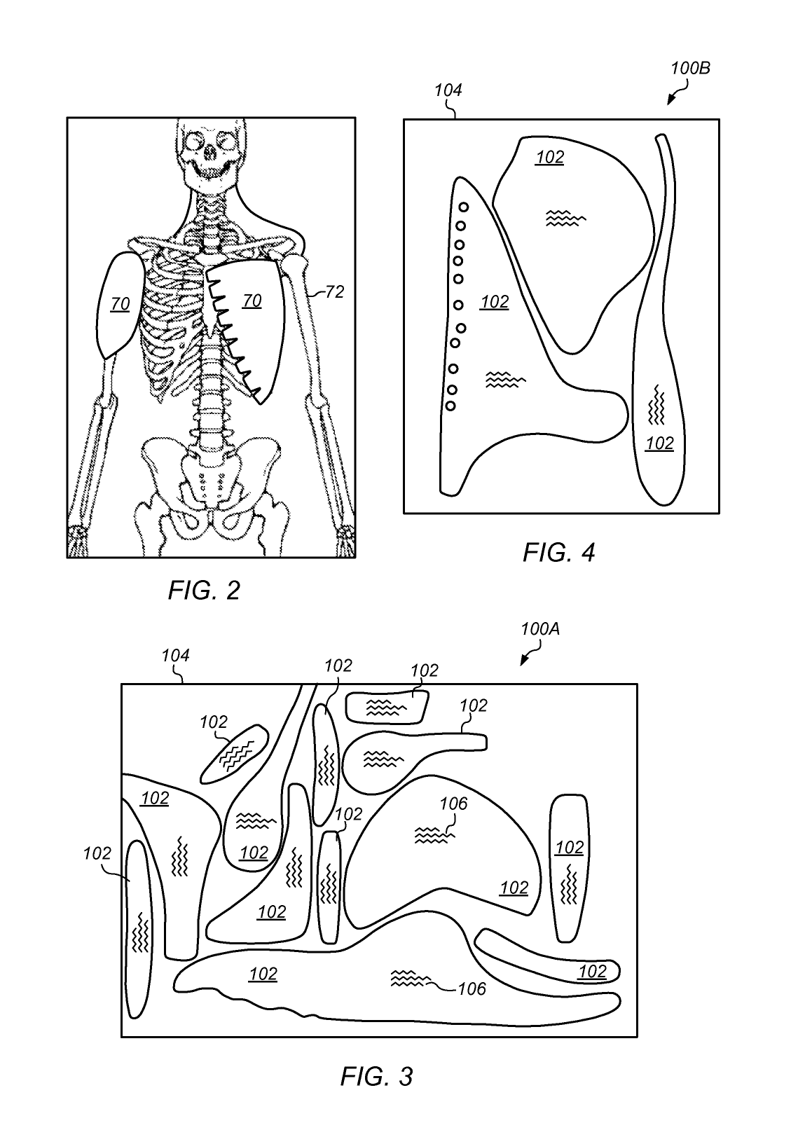

Process 50 may be repeated for each muscle desired to be represented in a set of muscle pieces or in a plurality of sets of muscle pieces. Thus, process 50 is used to form a plurality of patterns that represent muscles in the human body (e.g., process 50 is used to form muscle patterns using the fabric material). FIG. 2 depicts an example of an embodiment of muscle patterns 70 (e.g., fabric muscle patterns), formed using process 50, draped on skeleton 72.

Muscle patterns 70 produced using process 50 may be used to define muscle pieces on a sheet of material. FIG. 3-6 depict examples of embodiments of sets 100 of muscle pieces 102 defined on sheets 104. Muscle pieces 102 may be defined on sheets 104 by copying muscle patterns 70 onto the sheets (e.g., the muscle pieces have the same shapes or outlines as the muscle patterns). In some embodiments, muscle pieces 102 are the same size and shape as muscle patterns 70. In one embodiment, a muscle pattern is placed on sheet 104 and copied or traced to define a muscle piece on the sheet.

In some embodiments, muscle patterns 70 produced using process 50, shown in FIG. 1, are digitized (e.g., the muscle patterns are copied into a digital format using a scanning device and/or a computer program). The digital format of muscle patterns 70 may be used to print or otherwise transfer the shapes of the muscle patterns onto sheets 104 and define muscle pieces 102 on the sheets, as shown in FIGS. 3-6.

In certain embodiments, sheets 104 are made of a foam material (e.g., a closed cell foam material). Sheets 104 may, however, be made of any material that may be suitable for application onto, for example, a three-dimensional skeleton or other surface. Examples of other materials suitable for sheets 104 include, but are not limited to, fabric, leather, wood, plastic, metal, stretch materials such as neoprene or latex, paper or cardboard, pillowy or puffy materials, sticky gel products such as those used for window art. In some embodiments, sheets 104 are a material that sticks to a surface and is removable and re-useable (e.g., can be reapplied to the surface and stick again after removal).

In certain embodiments, muscle pieces 102 are shapes or patterns that correspond to muscles in the human body. Each muscle piece 102 may correspond to a particular muscle in the human body. For example, one muscle piece may correspond to a tricep muscle while another muscle piece corresponds to a bicep muscle. In some embodiments, one or more sets 100 of muscle pieces 102 correspond to major muscles in the human body. For example, sets 100 of muscle pieces 102 may correspond to about 80 major muscles in the human body. Limiting the sets of muscle pieces to major muscles may simplify use of the muscle pieces as there are over 600 muscles in the human body with a majority of those muscles being relatively small in scale. In some embodiments, sets 100 of muscle pieces 102 correspond to only one side of the body (e.g., the sets include muscle pieces for only either the left or right side of the body). It is to be understood that sets 100 of muscle pieces 102 shown in FIGS. 3-6 are merely presented as examples of sets of muscle pieces that may be provided and that any number of sets may include any number of muscle pieces to represent as many muscles in the human body as desired or needed.

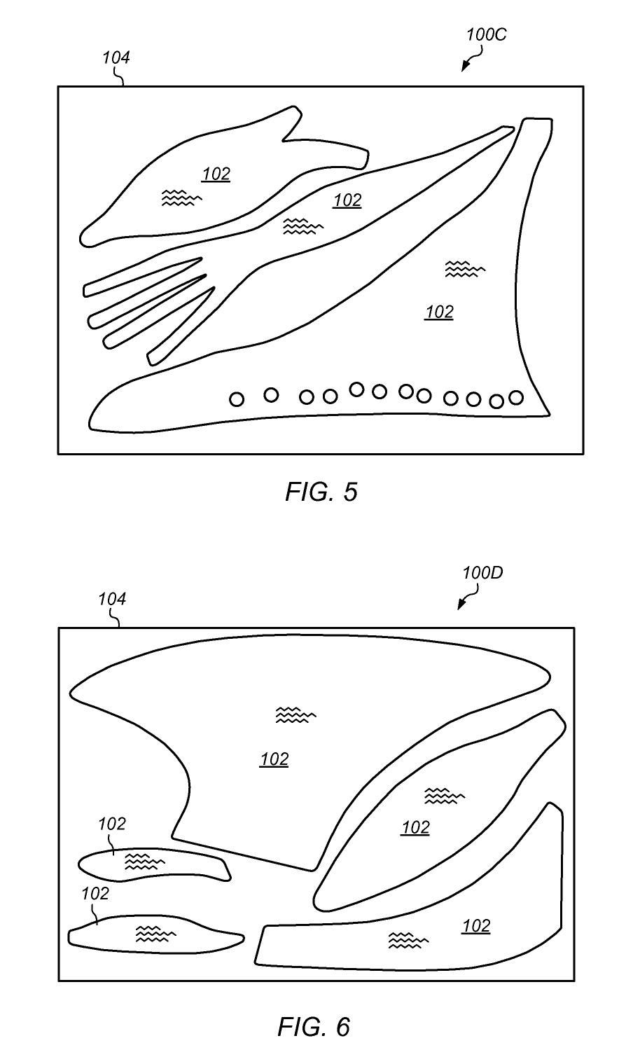

In certain embodiments, the color of sheets 104, and thus muscle pieces 102 on the sheets, vary in color based on characteristics of the muscles corresponding to the muscle pieces. In some embodiments, sheets 104 vary in color based on the depth in the body of the muscles corresponding to muscle pieces 102 on the sheets (e.g., different muscles pieces have different colors based on the layer the corresponding muscle is in the body). For example, muscle pieces 102 may be divided into four different base color groups based on four corresponding basic layers of muscles in the body. The four different base color groups may range according to the rainbow from, for example, red to purple (e.g., red, yellow, green, and purple may be base color groups). Red may represent deeper muscles with purple representing superficial muscles. For example, first set 100A, shown in FIG. 3, may include red muscle pieces 102 corresponding to a first (core) layer of the body. Second set 100B, shown in FIG. 4, may include yellow muscle pieces 102 corresponding to a second (intermediate) layer of the body. Third set 100C, shown in FIG. 5, may include green muscle pieces 102 corresponding to a third (intermediate) layer of the body. Fourth set 100D, shown in FIG. 6, may include purple muscle pieces 102 corresponding to a fourth (superficial) layer of the body.

In some embodiments, muscles pieces corresponding to muscles in the same layer but with different insertion points have the same base color but are different shades. For example, a biceps brachii is a superficial muscle so its corresponding muscle piece may be purple in color but because the biceps brachii inserts under the deltoid muscle (another superficial muscle), the biceps brachii muscle piece may be light purple while the deltoid muscle piece is dark purple. Varying the colors of the muscle pieces according to their corresponding layer in the body allows the user to build a rainbow as the muscle pieces are layered onto a three-dimensional skeleton. Though four base color groups are described, it is to be understood that any number of desired base color groups may be used ranging from any color to any color in the rainbow.

In some embodiments, a user removes muscle pieces 102 from sheets 104 by cutting the muscle pieces out of the sheet (e.g., cutting the muscle pieces out with a razor blade or other sharp instrument). In certain embodiments, the edges defining muscle pieces 102 are partially precut or slightly perforated to allow the muscle pieces to be removed from sheets 104 without cutting. For example, the edges defining muscle pieces 102 on sheets 104 are laser cut with perforations that allow the user to pull, punch, or tear out the muscle pieces.

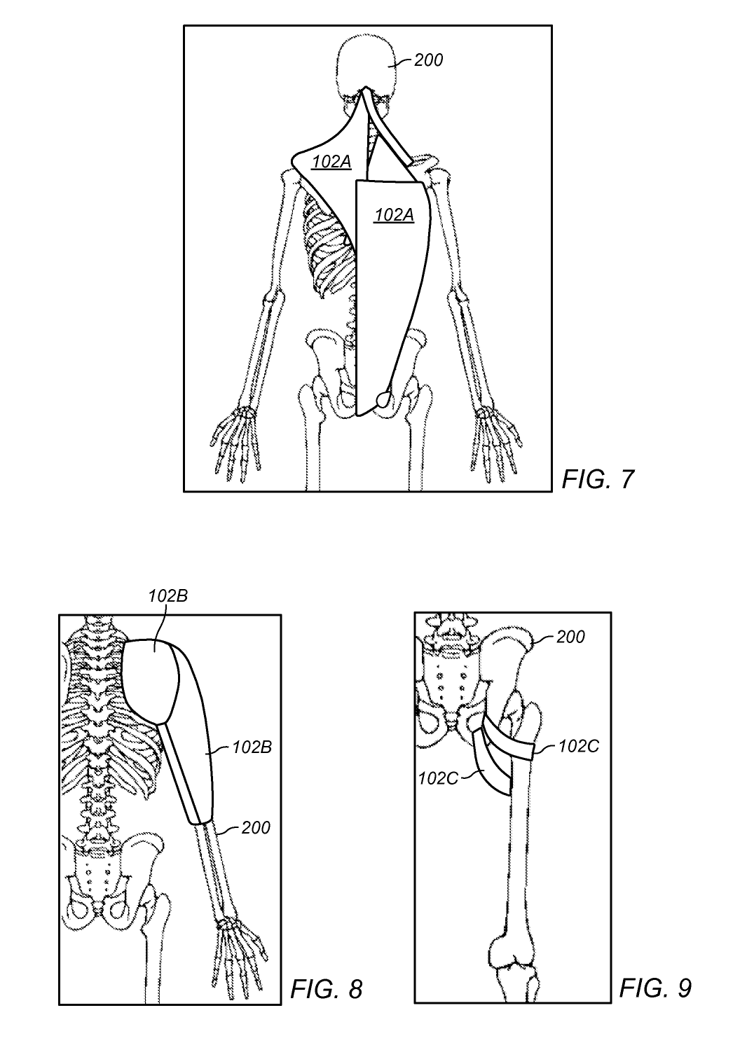

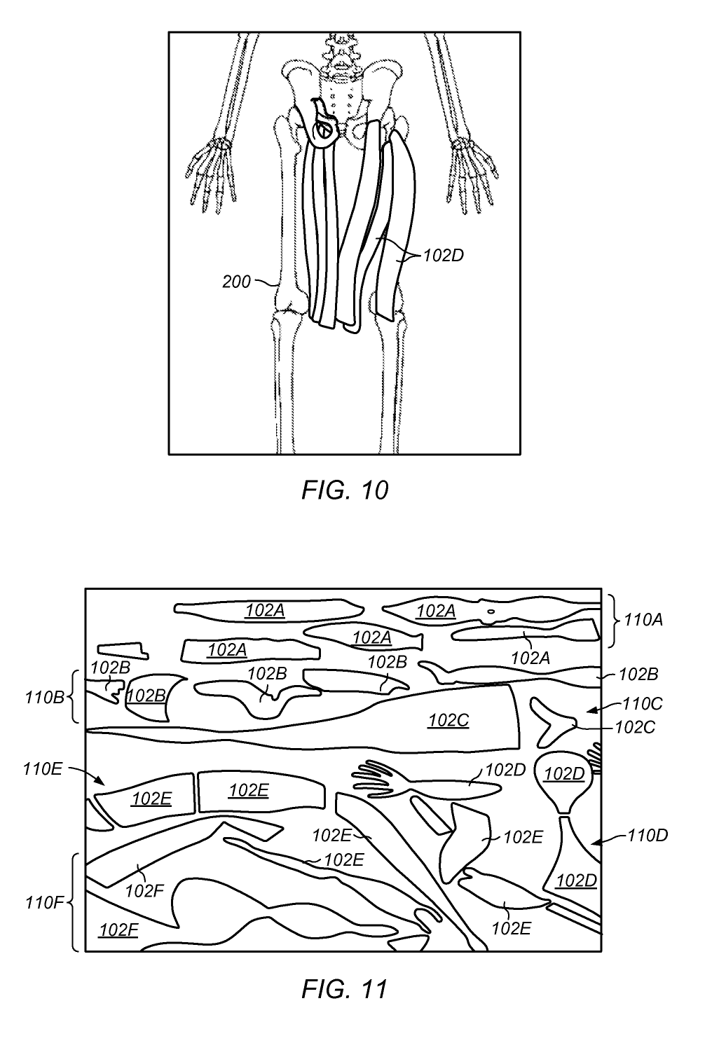

After removing individual muscle pieces 102 from sheets 104, the user may attach one or more of the individual muscle pieces to a model of a skeleton (e.g., a three-dimensional skeleton model) to gain a better understanding as to how the corresponding muscle is located in the body (e.g., a better understanding of the origin and insertion of the muscle). FIG. 7 depicts an example of back muscle pieces 102A placed on skeleton model 200. FIG. 8 depicts an example of arm muscle pieces 102B placed on skeleton model 200. FIG. 9 depicts an example of inner thigh muscle pieces 102C placed on skeleton model 200. FIG. 10 depicts an example of quadricep muscle pieces 102D placed on skeleton model 200.

In certain embodiments, as shown in FIGS. 7-10, one or more muscle pieces 102 are layered on skeleton model 200 (e.g., the muscle pieces may at least partially overlap each other when they are attached to the skeleton model). For example, as shown in FIG. 7, back muscle pieces 102A are shown partially overlapping. Because the muscle pieces may be placed separately (individually) and/or layered on skeleton model 200, the user may gain knowledge about the muscles and their interactions by learning where and how each separate (individual) muscle piece 102 is placed on the skeleton model. Placing separate and/or layered muscle pieces 102 on skeleton model 200 provides the user with an easy to understand and relatively inexpensive three-dimensional representation of the relationship of muscles in the human body. Separate and/or layered muscle pieces 102 also provide the ability to feel and place each individual muscle on a three-dimensional model, which may be particularly useful for persons with visual impairments.

In certain embodiments, muscle pieces 102 are attached to skeleton model 200 with a removable material (e.g., removable double sided tape such as foam tape). In some embodiments, muscle pieces 102 are made of a material that sticks to skeleton model 200 but is also removable from the skeleton. In some embodiments, muscle pieces 102 are attached to skeleton model 200 using fasteners (e.g., stick pins or magnets). In some embodiments, muscle pieces 102 are made of magnetic material and skeleton model 200 is magnetic such that the muscle pieces magnetically attach to the skeleton model. In some embodiments, skeleton model 200 includes hooks or other hangers that allows grommets or other openings at insertion points on muscle pieces 102 to be used to attach the muscle pieces to the skeleton model.

In certain embodiments, skeleton model 200 is a three-dimensional skeleton model. For example, skeleton model 200 may be a life size skeleton mobile that can hang from the ceiling or be mounted on a stand. In some embodiments, skeleton model 200 is an inflatable skeleton. In some embodiments, skeleton model 200 is a light weight model and can be disassembled, folded, and/or deflated for transport. In some embodiments, skeleton model 200 is itself assembled by the user for learning purposes. For example, pieces (e.g., bones) of skeleton model 200 may be coupled together using hooks, rings, wires, ties, clips, or other fasteners to form the skeleton model. In one embodiment, bones of the skeleton include grommets with a ring that threads through the grommets on bones that articulate with each other (e.g., hooking together bones in a hinge, ball and socket, or other joint-type found in the human body to simulate different relative bone movements). In some embodiments, skeleton model 200 is a two-dimensional skeleton model (e.g., a poster of a skeleton with front and back sides).

In certain embodiments, muscle pieces 102 and skeleton model 200 are life size representations of the muscles and the skeleton. In some embodiments, muscle pieces 102 and skeleton model 200 are scaled representations of the muscles and the skeleton (e.g., the muscle pieces and the skeleton model are ½ or ⅓ actual size).

In certain embodiments, each muscle piece 102 includes identifying information 106, as shown in FIG. 3, about its corresponding muscle on one side of the muscle piece. For example, identifying information 106 may be printed on one side of each muscle piece 102. Identifying information 106 may include, but not be limited to, name of the muscle, origin of the muscle, insertion of the muscle, action of the muscle, and/or muscle group for the muscle. Identifying information 106 may be used by the user to assist the user in proper placement and/or understanding of the corresponding muscle's function. In some embodiments, identifying information 106 is printed in braille or other aids for the visually impaired. The other side of muscle piece 102 may be blank to provide so that identifying information 106 may only be used as needed. For example, the user may be asked to place muscle piece 102 without using identifying information 106 unless needed.

In some embodiments, the negative space left in sheets 104 after muscle pieces 102 are removed from the sheets is used by the user to make an additional set of muscle pieces. For example, the user may use the negative space to trace the muscle pieces' shapes onto another material to make and use their own muscle pieces. In some embodiments, sheets 104 include labels at or near muscle pieces 102 that identify what muscle piece goes in the negative space after the muscle pieces are removed. In some embodiments, sheets 104 and muscle pieces 102 are coded using identification marks (e.g., identification numbers) that identify an area of the human body the muscle pieces are targeted for placement. For example, muscle pieces 102 may be coded with six identification numbers (e.g., 1, 2, 3, 4, 5, or 6) to identify which of six different areas of muscles on the human body the muscle pieces correspond (e.g., shoulders, chest, back, leg, arm, and bottom). In some embodiments, the identification marks are also included with the labels on sheets 104 that identify what muscle piece goes in the negative space after the muscle pieces are removed.

Using the negative space to define and make muscle pieces may decrease costs for the user by allowing the user to make their own copies of the muscle pieces (e.g., schools or other limited resource institutions may buy one set of muscle pieces and use it to make additional sets). In some embodiments, tracing and copying of the muscle pieces using the negative space provides a learning tool for the user. In some embodiments, negative space patterns are provided digitally to allow the user to download the muscle patterns to make and use their own muscle pieces.

In some embodiments, muscle pieces 102 are made of a material that simulates the flexibility of a real human muscle. For example, muscle pieces 102 may be made of a gel-like material that has similar flexibility to human muscle. Making muscle pieces 102 with such materials (and making the muscle pieces identical in size or slightly larger in size to their corresponding muscles) may provide muscle pieces that can be draped on an actual human body to demonstrate how muscles move when the human body moves.

In certain embodiments, muscle patterns produced by process 50, shown in FIG. 1, are used to produce fascial line pieces. For example, fascial line pieces may be produced by combining muscle patterns (or muscle pieces) that correspond to different muscles found along a fascial line in the human body. FIG. 11 depicts examples of different sets of muscle pieces 102A-F aligned into different fascial line pieces 110A-F. Each fascial line piece 110 may correspond to a particular fascial line in the human body. The number of fascial line pieces 110 used to represent the fascial lines in the human body may depend on the number of muscle pieces 102 used to represent the human body. For example, about 12 fascial line pieces 110 may correspond to sets of muscle pieces 102 representing about 80 major muscles in the human body. It is to be understood that fascial line pieces 110 shown in FIG. 11 are merely presented as examples of fascial line pieces that may be provided and that any number of fascial line pieces may be represented as desired or needed.

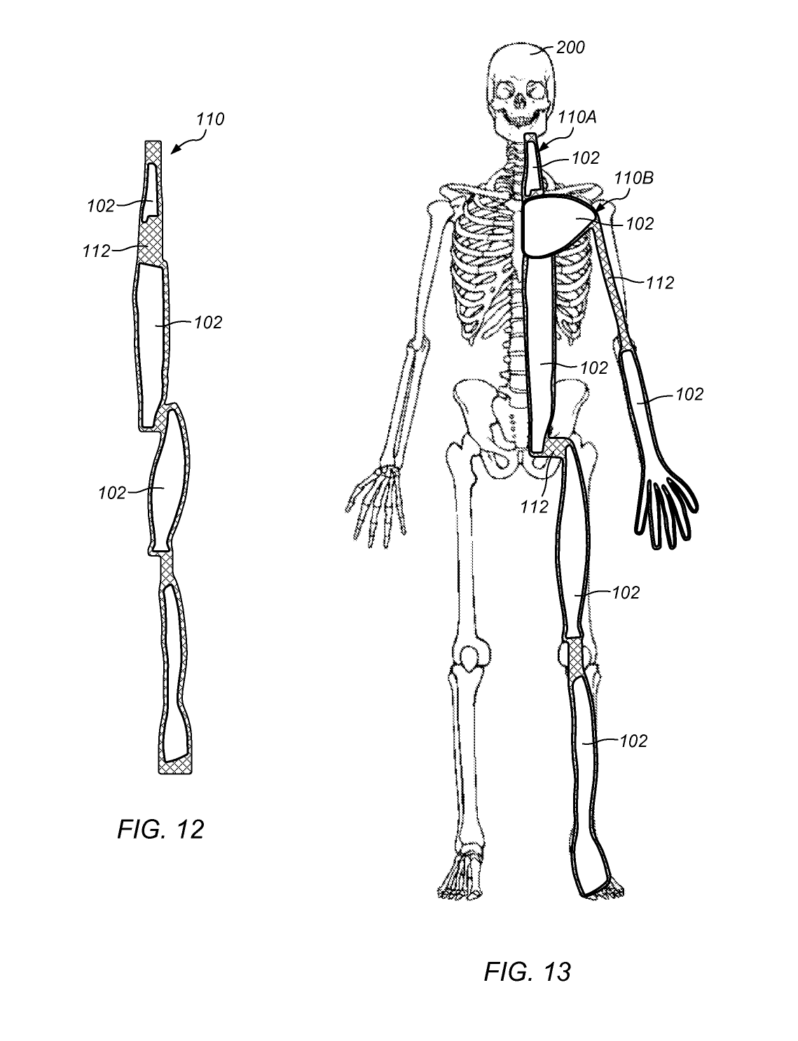

In certain embodiments, muscle pieces 102 in fascial line pieces 110 are made of a different material than the individual muscle pieces shown in FIGS. 3-10. For example, muscle pieces 102 in fascial line pieces 110 may be made of fleece material (e.g., stretchy fleece material such as poly fleece). Muscle pieces 102A-F, shown in FIG. 11, are coupled together to form fascial line pieces 110A-F. Muscle pieces 102A-F may be coupled together using a fascial linking material. FIG. 12 depicts an embodiment of muscle pieces 102 coupled together using fascial linking material 112 to form fascial line piece 110. In certain embodiments, muscle pieces 102 are enclosed, or at least partially enclosed, in fascial linking material 112. Fascial linking material 112 may be used to represent fascia in the human body. Fascial linking material 112 may be, for example, a fabric netting (e.g., a stretchy fabric netting).

Fascial line pieces 110 may be placed on (e.g., wrapped around or draped on) a skeleton model (such as skeleton model 200 shown in FIGS. 7-10) corresponding to the placement of fascia and fascial lines on the human body. In some embodiments, two or more fascial line pieces are positioned on a skeleton model at the same time. FIG. 13 depicts an example of two fascial line pieces 110A, 110B placed on skeleton model 200. Fascial line pieces 110A, 110B may be separately placed on skeleton model 200. In certain embodiments, fascial line pieces 110A, 110B are coupled to or attached to skeleton model 200. For example, fascial line pieces 110A, 110B may be attached to skeleton model 200 using double side tape or other adhesives such as those described for muscle pieces above. In some embodiments, fascial line pieces 110A, 110B at least partially overlap (e.g., the fascial line pieces are placed in layers on the skeleton model with some overlap between the layers). In some embodiments, one or more fascial line pieces are placed on (e.g., draped over) a human being. For example, the fascial line pieces may be placed on the human being to provide visual guidance for treatment of the human being (e.g., for massage treatment of the fascial lines).

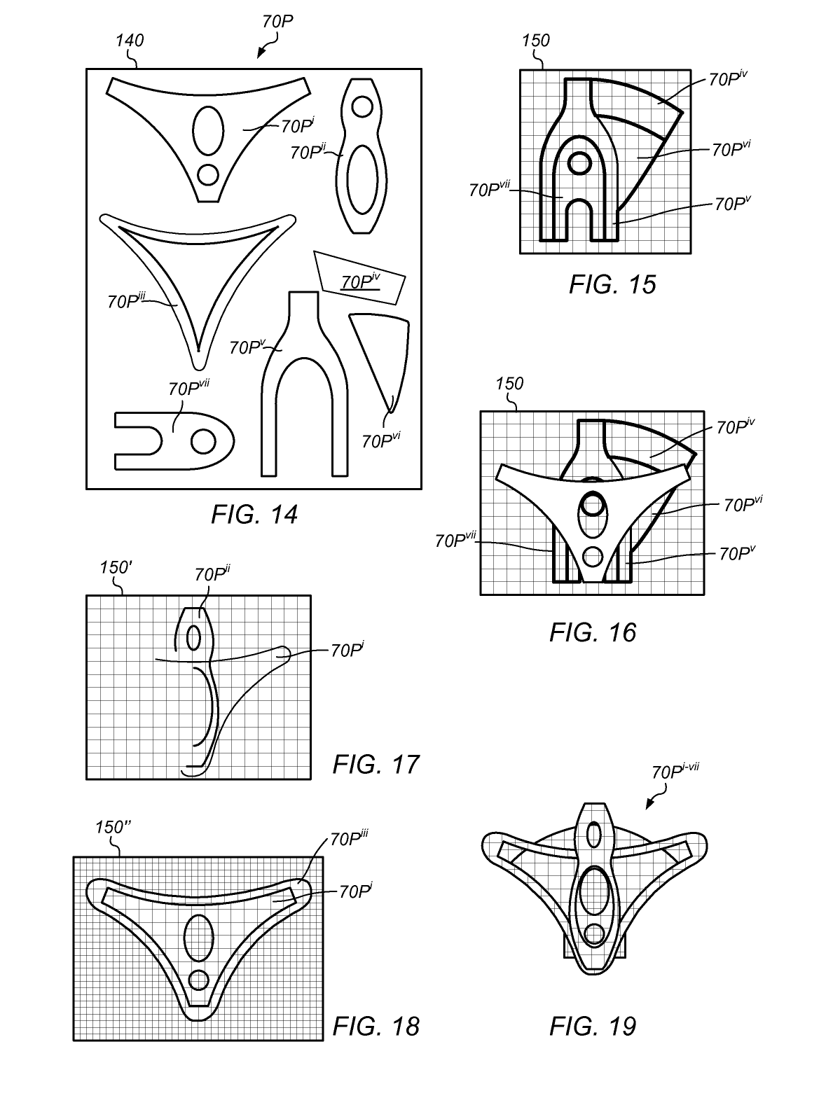

FIGS. 14-25 depict an example of an embodiment for producing pelvic floor muscle patterns and a corresponding pelvic floor fascial line piece. FIG. 14 depicts an example of an embodiment of pelvic floor muscle patterns 70P corresponding to the seven major pelvic floor muscles (70Pⁱ-70P^{vii}) on sheet 140. Muscle patterns 70P may be produced using an embodiment of process 50, shown in FIG. 1.

In certain embodiments, pelvic floor muscle patterns 70P are sized to fit together properly (e.g., fit together like puzzle pieces). In one embodiment, pelvic floor muscle patterns 70P are sized by placing the muscle patterns on top of each other on graph paper one by one. FIGS. 15-19 depict examples of the various steps in the embodiment of sizing using graph paper.

FIG. 15 depicts an example of outlines of muscle patterns 70P^{iv}, 70P^{v}, 70P^{vi}, and 70P^{vii} traced on graph paper 150. FIG. 16 depicts an example of muscle pattern 70P¹ layed on top of the outlines of muscle patterns 70P^{iv}, 70P^{v}, 70P^{vi}, and 70P^{vii} on graph paper 150. FIG. 17 depicts an example of partial outlines of muscle patterns 70Pⁱⁱ and 70Pⁱⁱⁱtraced on graph paper 150′. FIG. 18 depicts an example of cutouts of muscle patterns 70Pⁱ and 70Pⁱⁱⁱ placed on graph paper 150″. FIG. 19 depicts an example of cutouts of all seven muscle patterns 70P (70Pⁱ-70P^{vii}) overlayed to show the proper fit together of the muscle patterns. As shown in FIG. 19, all seven muscle patterns 70P (70Pⁱ-70P^{vii}) fit together both vertically and laterally.

Once muscle patterns 70P are designed to fit together, the muscle patterns may be layed out on sheet 140, as shown in FIG. 14. Sheet 140 may be, for example, a sheet of paper. Muscle patterns 70P on sheet 140 may be used as a master outline of the patterns for producing the muscle patterns on other materials (e.g., fabric or foam).

In certain embodiments, individual muscle pieces are made out of fabric material (e.g., fleece material) using muscle patterns 70P to define the muscle pieces. One or more of the muscle pieces may be placed on one or more pieces of fascial linking material (e.g., a stretchy mesh material) before coupling the muscle pieces together. For example, muscle pieces may be placed on fascial linking materials corresponding to the interaction of muscles and fascia in the pelvic floor muscle region of the human body.

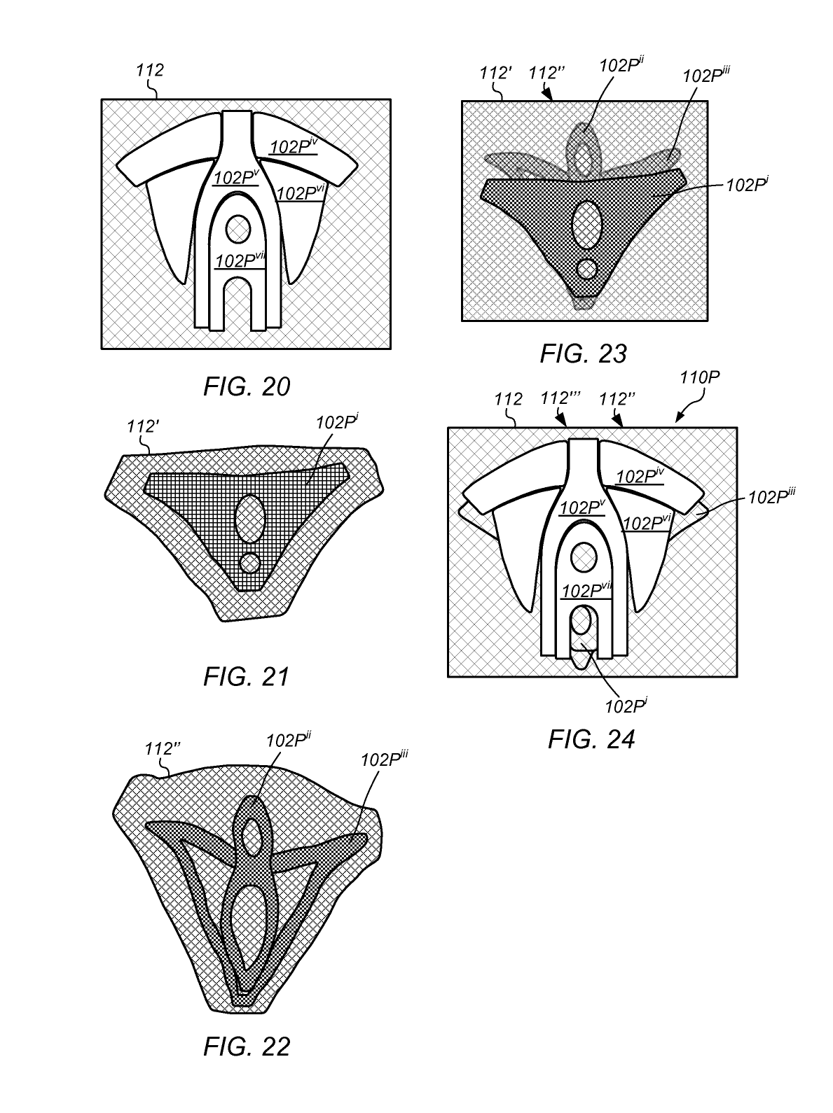

FIG. 20 depicts an example of an embodiment of muscle pieces 102P^{iv}, 102P^{v}, 102P^{vi}, and 102P^{vii} placed on fascial linking material 112. Muscle pieces 102P^{iv}, 102P^{v}, 102P^{vi}, and 102P^{vii} and fascial linking material 112 may correspond to a first level of the pelvic floor muscle region. FIG. 21 depicts an example of an embodiment of muscle piece 102Pⁱ placed on fascial linking material 112′. Muscle piece 102Pⁱ and fascial linking material 112′ may correspond to a second level of the pelvic floor muscle region. FIG. 22 depicts an example of an embodiment of muscle pieces 102Pⁱⁱ and 102Pⁱⁱⁱ placed on fascial linking material 112″. Muscle pieces 102Pⁱⁱ and 102Pⁱⁱⁱ and fascial linking material 112″ may correspond to a third level of the pelvic floor muscle region

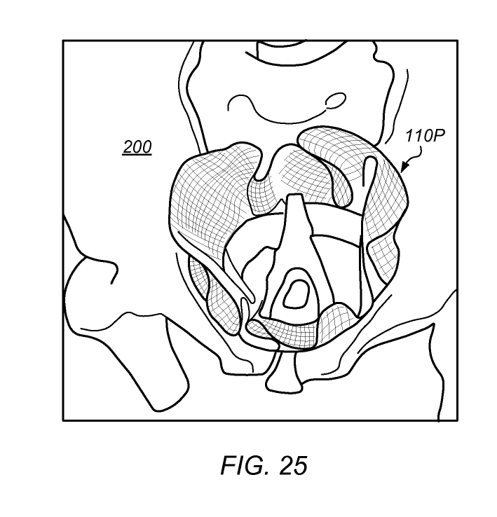

In certain embodiments, the different levels of muscle pieces 102P and fascial linking material 112 are placed on top of each other to provide a complete pelvic floor fascial line piece. For example, the second level of muscle pieces may be placed on the third level of muscle pieces and the first level of muscle pieces may be placed over the second level of muscle pieces to provide the complete pelvic floor fascial line piece. FIG. 23 depicts an example of an embodiment of muscle piece 102Pⁱ and fascial linking material 112′ (the second level) layered on top of muscle pieces 102Pⁱⁱ and 102Pⁱⁱⁱ and fascial linking material 112″ (the third level). FIG. 24 depicts an example of an embodiment of muscle pieces 102P^{iv}, 102P^{v}, 102P^{vi}, and 102P^{vii} and fascial linking material 112 layered over the pieces shown in FIG. 23 to produce pelvic floor fascial line piece 110P.

Layering the muscle pieces and fascial linking material, as shown in FIG. 24, couples the muscle pieces and the fascial linking materials together. Thus, in one embodiment, pelvic floor fascial line piece 110P includes three layers of muscle pieces on three layers of fascial linking material placed one on top of the other (e.g., the muscle pieces are coupled by placing the layers of fascial linking material on top of each other).

After forming pelvic floor fascial line piece 110P, the fascial line piece may be placed in the pelvic floor area of skeleton model 200, as shown in FIG. 25. In certain embodiments, individual muscle pieces 102P are made of fabric of different colors. Making muscle pieces 102P in pelvic floor fascial line piece 110P out of different colors may allow a user to better identify each muscle when the pelvic floor fascial line piece is placed in skeleton model 200.

It is to be understood that although the above embodiments are directed towards the muscles in the human body, one of ordinary skill in the art would understand that the above processes and structures may be applied to muscles in other animals (e.g., dogs, horses, etc.). It is also contemplated that other systems in the body may also be represented using similar techniques to those described herein. For example, internal organs may be represented with foam structures (e.g., three-dimensional foam structures) and/or the nervous system may be represented with wires for the nerves.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a body” includes a combination of two or more bodies and reference to “a material” includes mixtures of materials.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system, comprising:
a plurality of muscle pieces, wherein each muscle piece corresponds to an individual muscle in a human body, and wherein each muscle piece is configured to be attached to a skeleton model of the human body at a location of the muscle to which the muscle piece corresponds;
wherein each muscle piece is configured to be separately attached to the skeleton model;
wherein the muscle pieces are configured to be attached to the skeleton model in one or more layers on the skeleton model; and
wherein the muscle pieces are configured to be both attached to and removed from the skeleton model during use.

2. The system of claim 1, wherein the skeleton model is a three-dimensional skeleton model.

3. The system of claim 1, wherein each muscle piece is configured to be repeatedly attached to and repeatedly removed from the skeleton model during use.

4. The system of claim 1, wherein the muscle pieces comprise varying colors that are varied to correspond to different layers of muscle in the human body, and wherein each muscle piece comprises a color corresponding to the layer of its corresponding muscle in the human body.

5. The system of claim 1, wherein at least two muscle pieces at least partially overlap when attached to the skeleton model.

6. The system of claim 1, wherein each muscle piece is configured to be attached to the skeleton model at a point of insertion and/or origin in the human body of the corresponding muscle.

7. The system of claim 1, wherein the muscle pieces correspond to major muscles of the human body.

8. The system of claim 1, wherein the plurality of muscle pieces is formed on a sheet of material, and wherein a user removes the muscles pieces from the sheet of material.

9. The system of claim 8, wherein negative spaces left in the sheet by the removed muscle pieces can be used as patterns for forming additional identical muscle pieces.

10. The system of claim 1, wherein each muscle piece comprises identifying information pertaining to its corresponding muscle on one side of the muscle piece.

11. A method for forming a muscle pattern corresponding to a selected muscle in a human body, comprising:
draping a piece of material on a three-dimensional model of a skeleton at a location of the selected muscle on the human body;
drawing a pattern of the selected muscle on the material piece;
removing the material piece from the skeleton model;
straightening out the muscle pattern on the material piece;
cutting out the muscle pattern from the material piece;
redraping the muscle pattern on the skeleton model;
assessing a shape and size of the muscle pattern to see if the muscle pattern properly represents the selected muscle when the muscle pattern is draped on the skeleton; and
fine-tuning the shape and size of the muscle pattern as needed until the muscle pattern properly represents the selected muscle when the muscle pattern is draped on the skeleton.

12. The method of claim 11, further comprising using the muscle pattern to define a muscle piece on a sheet of material corresponding to the selected muscle.

13. The method of claim 11, further comprising converting the muscle pattern into a digital format.

14. The method of claim 13, further comprising using the digital format of the muscle pattern to define a muscle piece on a sheet of material corresponding to the selected muscle.

15. The method of claim 11, wherein fine-tuning the shape and size of the muscle pattern comprises removing the muscle pattern from the skeleton model, recutting the muscle pattern, redraping the muscle pattern on the skeleton model, and reassessing the shape and size of the muscle pattern.

16. The method of claim 11, wherein straightening out the muscle pattern comprises transposing the muscle pattern from a three-dimensional curved pattern to a flat, two-dimensional pattern and drawing a fine-tuned shape of each muscle pattern.

17. The method of claim 11, wherein the piece of material comprises a piece of fabric material.

18. The method of claim 11, further comprising repeating the method with additional pieces of material to form additional muscle patterns for additional selected muscles in the human body.

19. A system, comprising:
one or more fascial line pieces, wherein each fascial line piece corresponds to an individual fascial line of muscles in a human body, and wherein each fascial line piece is configured to be separately placed on a skeleton model of the human body at a location of the fascial line of muscles to which the fascial line piece corresponds;
wherein each fascial line piece comprises two or more muscle pieces coupled together in one or more fascial linking materials, and wherein each muscle piece corresponds to an individual muscle in the fascial line of muscles to which the fascial line piece corresponds; and
wherein the fascial line pieces are configured to be both placed on and removed from the skeleton model.

20. The system of claim 19, wherein the skeleton model is a three-dimensional skeleton model.

21. The system of claim 19, wherein the fascial linking materials correspond to fascia in the human body.

22. The system of claim 19, wherein each fascial line piece is configured to be repeatedly placed on and repeatedly removed from the skeleton model during use.

23. The system of claim 19, wherein the fascial line pieces are configured to be draped over a human being.

24. The system of claim 19, wherein at least two fascial line pieces at least partially overlap when placed on the skeleton model.

25. The system of claim 19, wherein at least one of the fascial line pieces comprises pelvic floor muscle pieces and the pelvic floor fascial line piece is placed on a pelvic area of the skeleton model during use.

26. The system of claim 19, wherein the muscle pieces comprise varying colors that are varied to correspond to different layers of muscle in the human body, wherein each muscle piece comprises a color corresponding to the layer of its corresponding muscle in the human body, and wherein each fascial line piece comprises muscle pieces with substantially the same color.
